(19) United States
(12) Patent Application Publication
(10) Pub. No.: US 2017/0188088 A1
(43) Pub. Date: Jun. 29, 2017

(54) AUDIO/VIDEO PROCESSING UNIT, SPEAKER, SPEAKER STAND, AND ASSOCIATED FUNCTIONALITY

(71) Applicant: PWV Inc, Bellevue, WA (US)

(72) Inventors: Jeremy Adam Hammer, Kirkland, WA (US); James Andrew Hammer, Kirkland, WA (US)

(21) Appl. No.: 15/391,505

(22) Filed: Dec. 27, 2016

Related U.S. Application Data
(60) Provisional application No. 62/387,374, filed on Dec. 24, 2015.

(51) Int. Cl. H04N 21/431; H04N 21/4363; H04N 21/435; H04N 21/84

(52) U.S. Cl. CPC H04N 21/4312; H04N 21/84; H04N 21/43635; H04N 21/435

(57) ABSTRACT

A method and/or system for assigning an icon to a multimedia content source is provided. The method may include obtaining, at an audio/video processing device, an identifier for the multimedia content source, using the identifier to locate an icon, and displaying the icon at an output device.

### CROSS REFERENCE TO RELATED APPLICATIONS

The present application claims the benefits of and priority, under 35 U.S.C. §119(e), to U.S. Provisional Application Ser. No. 62/387,374, filed Dec. 24, 2015, entitled “Audio/Video Processing Unit, Speaker, Speaker Stand, and Associated Functionality,” the entire disclosure of which is hereby incorporated by reference, in its entirety, for all that it teaches and for all purposes.

### FIELD

The present disclosure is generally directed to audio/video processing units, methods, and systems, in particular, toward audio/video processing units, speakers, speaker stand, and associated functionality thereof.

### BACKGROUND

There tends to be a general lack of simplicity when it comes to setting up and configuring home theatre systems. In the ecosystem of home theatre systems for example, a more enjoyable experience will be had by the user when the amount of effort required by the user to set up, configure, and use such a system is minimal. For example, installing, running, and configuring speaker wires for use in home theatre systems may present a challenge for the user and may be a primary reason most users do not have a home theatre system. Furthermore, not being able to remember which device is connected to which audio/video input of such a system or easily find and/or select such device may tend to decrease user satisfaction.

### BRIEF DESCRIPTION OF THE DRAWINGS

FIG. 1 shows details of a wireless audio/video distribution system in accordance with at least some embodiments of the present disclosure;

FIG. 2 illustrates one or more speaker configurations in accordance with embodiments of the present disclosure;

FIG. 3 illustrates details of one or more speakers in accordance with embodiments of the present disclosure;

FIG. 4 illustrates a block diagram of one or more audio/video processing unit(s) in accordance with embodiments of the present disclosure;

FIG. 5 illustrates a block diagram of one or more mobile devices in accordance with embodiments of the present disclosure;

FIG. 6 illustrates a data structure and a screen accent color picker in accordance with embodiments of the present disclosure;

FIG. 7 depicts a first screen shot provided by an audio/video processing unit and displayed on one or more output devices in accordance with embodiments of the present disclosure;

FIG. 8 depicts a second screen shot provided by the audio/video processing unit and displayed on the one or more output devices in accordance with embodiments of the present disclosure;

FIG. 9 depicts a third screen shot provided by the audio/video processing unit and displayed on the one or more output devices in accordance with embodiments of the present disclosure;

FIG. 10 depicts a fourth screen shot provided by the audio/video processing unit and displayed on the one or more output devices in accordance with embodiments of the present disclosure;

FIG. 11 depicts a speaker stand assembly in accordance with another embodiment of the present disclosure;

FIG. 12 depicts a speaker assembly in accordance with embodiments of the present disclosure;

FIG. 13 depicts additional details of a baffle of a speaker assembly in accordance with embodiments of the present disclosure;

FIG. 14 depicts a front view of a speaker enclosure in accordance with embodiments of the present disclosure;

FIG. 15 depicts a bottom view of the speaker enclosure in accordance with embodiments of the present disclosure;

FIG. 16 depicts additional details of a mount locator in accordance with embodiments of the present disclosure;

FIG. 17 depicts additional details of a speaker foot in accordance with embodiments of the present disclosure; and

FIG. 18 depicts a first communication flow diagram in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

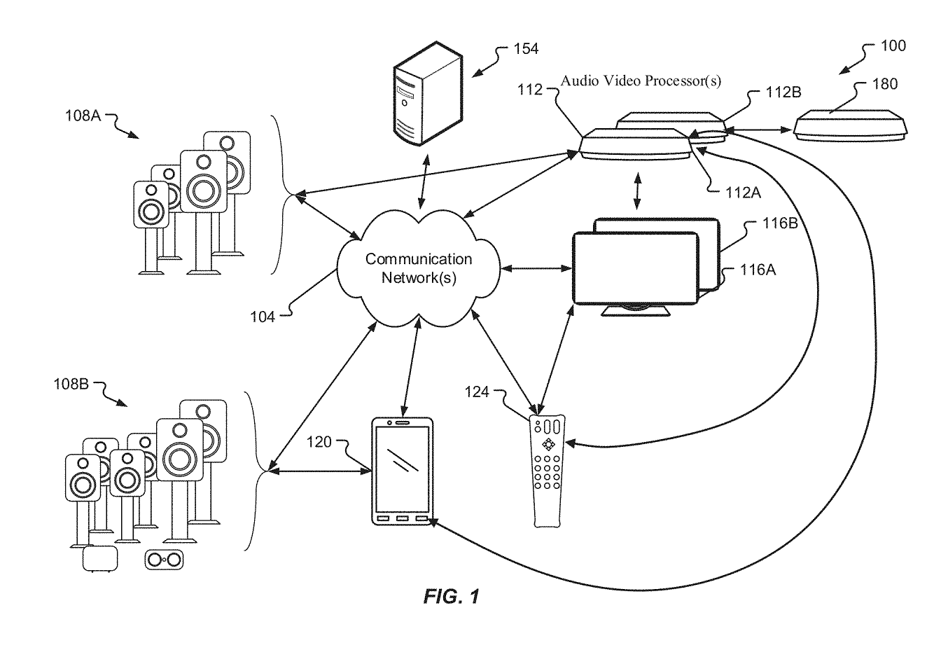

Referring initially to FIG. 1, details of a wireless audio/video distribution system 100 are depicted in accordance with at least some embodiments of the present disclosure. The wireless audio/video distribution system 100 generally provides time-synchronized wireless audio to one or more zones, or groups, of wireless audio speakers. The wireless audio/video distribution system 100 may include one or more communication networks 104, one or more speaker groups 108A-108B having one or more speakers, one or more wireless audio/video processors 112A-112B, one or more televisions 116A-116B, one or more mobile devices 120, and one or more remote controls 124 interacting with or otherwise configuring the audio/video processing unit 112, the television 116, and/or the one or more speaker groups 108A-108B.

The one or more communication networks 104 may comprise any type of known communication medium or collection of communication media and may use any type of known protocols to transport messages between endpoints. The communication network 104 is generally a wireless communication network employing one or more wireless communication technologies; however, the communication network 104 may include one or more wired components and may implement one or more wired communication technologies. The Internet is an example of the communication network that constitutes an Internet Protocol (IP) network consisting of many computers, computing networks, and other communication devices located all over the world, which are connected through many networked systems and other means. Other examples of components that may be utilized within the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network need not be limited to any one network type, and instead may be comprised of a number of different networks and/or network types. The communication network 104 may further comprise, without limitation, one or more Bluetooth networks implementing one or more current or future Bluetooth standards, one or more device-to-device Bluetooth connections implementing one or more current or future Bluetooth standards, wireless local area networks implementing one or more 802.11 standards, such as, but not limited to, 802.11a, 802.11b, 802.11c, 802.11g, 802.11n, 802.11ac, 802.11as, and 802.11v standards, and/or one or more device-to-device Wi-Fi-direct connections.

Referring again to FIG. 1, the mobile device 120 may be associated with a user and may correspond to any type of known communication equipment or collection of communication equipment operatively associated with at least one communication module and antenna or transceiver. The mobile device 120 may be any device for carrying out functions, instructions, and/or may be utilized to communicate with the audio/video processing unit 112, and/or directly with the one or more speakers and/or speaker groups 108A-108B utilizing communication network 104 and/or a direct connection, via Bluetooth, Wi-Fi Direct, a proprietary direct connection, or otherwise. The mobile device 120 may communicate with one or more audio/video processing units 112A-112B either directly or via the communication network 104. Moreover, the mobile device 120 may communicate with and/or otherwise control one or more of the audio/video processing units 112A-112B via one or more apps, or applications.

Examples of a suitable mobile device 120 may include, but are not limited to, a personal computer, laptop, Personal Digital Assistant (PDA), cellular phone, smart phone, tablet, mobile computing device, handheld radio, dedicated mobile device, and/or combinations thereof. In general, the mobile device 120 is capable of providing one or more audio streams to one or more speakers and/or one or more speaker groups 108A-108B. The mobile device 120 may optionally have a user interface to allow a user to interact with the mobile device 120. The user interface may optionally allow a user to make configuration changes to one or more speakers and/or one or more speaker groups 108A-108B directly or indirectly. For example, the user may utilize the mobile device 120 to interact with and/or otherwise navigate a speaker setup process. As another example, the mobile device 120 may be utilized to interface with, and/or navigate, an onscreen display provided at least in part by one or more audio/video processing units 112A-112B.

Speaker groups 108A-108B may be a collection of one or more speakers capable of receiving, playing, and/or transmitting audio information. The audio information may comprise one or more digital audio streams or one or more multichannel digital audio streams that are received from a variety of connected devices, such as mobile device 120 and/or the audio/video processing unit 112. Each of the speaker groups 108A-108B may receive content and/or be paired to each of the audio/video processing units 112A-112B, either individually or at the same time. The audio information may be encrypted, encoded, and/or provided as a protected content stream. In some embodiments, and in accordance with the present disclosure, the digital audio stream may be a Bluetooth Audio stream, which may be compressed utilizing one or more compression CODECs, such as, but not limited to, MPEG. The Bluetooth Audio stream may be sent to a processor or microcontroller within a speaker of the speaker group 108A-108B, where the audio stream may be decoded and separated into a number of discrete individual channels. These channels may include, but are not limited to, Stereo, Stereo with Subwoofer, Dolby or DTS 5.1 Surround Sound, and/or any other multichannel or mono formats. That is, the speaker groups 108A-108B may utilize a varying number of speakers and provide a varying number of configurations with a varying number of channels.

Once the individual channels are extracted and decoded, one of the channels may be played back on the local speaker. Other channels may be sent to any number of other speakers using a standard wireless protocol like WiFi. Each speaker may contain a Bluetooth radio and a WiFi radio for transmitting and receiving the digital audio streams such that each speaker may play back one or more channels of audio. Standard Internet Protocol may be used to assign IP addresses to each speaker for communication purposes and a universally unique identifier (UUID) assigned to each speaker, via the simple service discovery protocol (SSDP), may be used to identify and assign the audio channel each speaker is assigned to or is playing back.

Referring again to FIG. 1, remote control device 124 may be operative to communicate a command to a peripheral device to elicit functionality of the peripheral device. The remote control device 124 is able to store, serve, compute, communicate, and/or display information to enable a user to control one or more peripheral devices, such as the television 116, the audio/video processing unit 112, and/or one or more speakers of the one or more speaker groups 108A-108B. Although remote control device 124 is depicted as a standalone remote control device, such remote control functionality may be provided in and from a mobile device, such as mobile device 120. The remote control device 124 may include one or more navigation buttons, such as up, down, left, right, and select/enter buttons.

Each of the wireless audio/video processing units 112A-112B provides coded and/or decoded audio data, such as, but not limited to, pulse code modulated integrated interchip sound (PCM/I2S) audio data, to one or more speakers of the speaker groups 108A-108B utilizing one or more wireless protocols. That is, the wireless audio/video processing unit 112 does not use a physical connection to the one or more speakers of the speaker groups 108A-108B as a medium for transmitting the wireless audio. As previously mentioned, the audio data may be provided in a PCM format; however, in some embodiments, the audio data may be provided in formats other than PCM. Alternatively, or in addition, the audio data may be provided in both PCM format and formats other than PCM. Alternatively, or in addition, each of the wireless audio/video processing units 112A-112B provides video to one or more televisions 116A-116B.

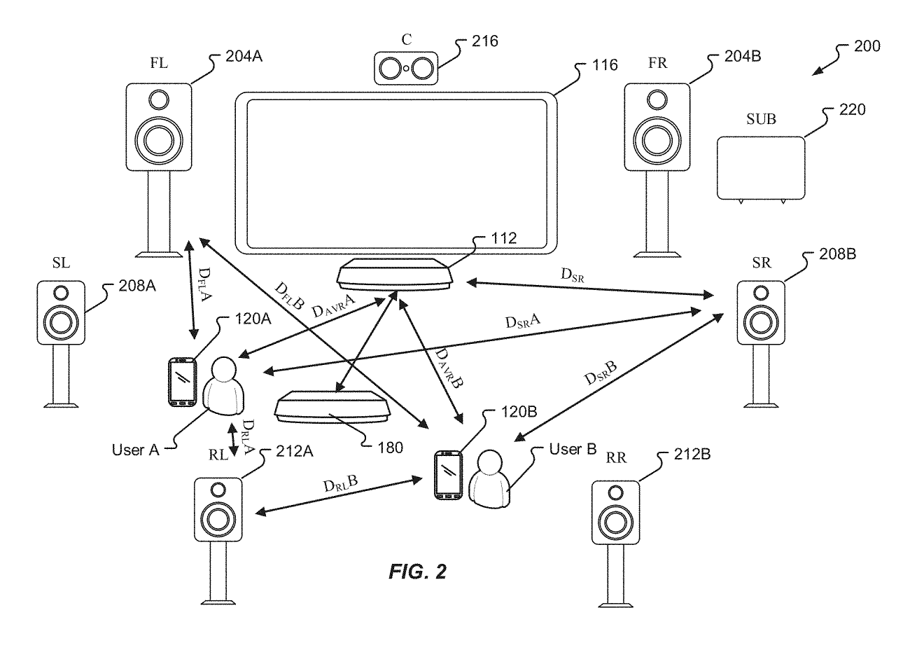

FIG. 2 illustrates one or more speaker configurations 200 in accordance with embodiments of the present disclosure. That is, speaker groups 108A-108B may utilize a configuration similar to or the same as that which is illustrated in speaker configuration 200. The speaker configuration 200 generally represents a 7.1 surround sound configuration having a front left speaker 204A, a front right speaker 204B, a side left speaker 208A, a side right speaker 208B, a rear left speaker 212A, a rear right speaker 212B, a center speaker 216, and a subwoofer 220. Speaker configuration 200 generally represents an eight-channel surround audio system commonly used in home theatre configurations. Although illustrated as including eight speakers and eight channels, speaker configuration 200 may be of a different surround sound configuration and include more or less than eight speakers and eight channels. Alternatively, or in addition, more than one speaker may be assigned to the same channel. For example, in a 7.2 surround sound configuration, two subwoofers may be utilized to increase, or otherwise enhance, the bass. In some embodiments, one or more speakers and/or one or more channels may be utilized based on an exact location of the speaker. That is, in some circumstances, one or more speakers and one or more corresponding channels may be utilized to provide precise sounds from specific locations to simulate select sounds, such as a helicopter, rain, or other sounds that may or may not include a specific positional component.

FIG. 2 further depicts various listening locations in relation to one or more speakers and/or one or more audio/video processing units 112. In that a location of a listening user may be used to calibrate and/or adjust parameters associated with a listening experience, system 200 may be capable of utilizing a device, such as the mobile device 120, to determine a position of a user and make such adjustments. Further, the audio/video processor 112 may, with the cooperation of an app running on the mobile device 120, make additional measurements including, but not limited to, speaker position relative to one or more speakers, one or more audio/video processors 112, and/or one or more users, individual and collective speaker volume levels, room dimensions, room acoustics, sound decay, and additional audio characteristics to adjust one or more parameters, such as ,but not limited to, volume levels, subwoofer-to-satellite crossover frequencies, signal delay, echo, muddy sound, speaker positioning, individual listener preferences and/or deficiencies, and/or other artifacts that may affect a listening experience. Moreover, equalization of speakers individually and as a group may be performed.

A non-limiting example of at least one measurement performed by system 200 may include playing one or more test tones from one or more speakers and calculating a time of flight between the one or more speakers and a mobile device 120 receiving the audio test tone. Accordingly, based on the time of flight, a distance between the mobile device 120 and the one or more speakers may be determined. Alternatively, or in addition, a tone may be played at one or more speakers and a level, or loudness, of the speaker may be adjusted based on an audio level received at the mobile device 120. Accordingly, if a user, such as User A is located closer to the front left speaker 204A, but farther from the front right speaker 204B for example, the volume of the front left speaker 204A may be reduced while the volume of the front right speaker 204B may be increased. Of course, other speakers may be adjusted as well. Additionally, other volume and other speaker volume combinations are contemplated.

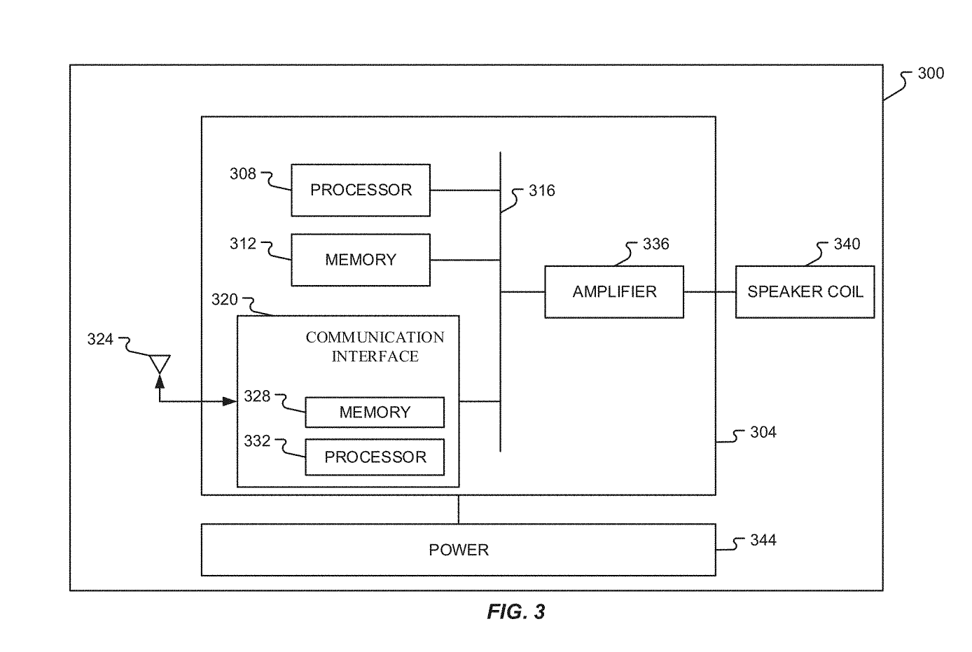

FIG. 3 illustrates details of one or more speakers 300 in accordance with embodiments of the present disclosure. Speaker 300 may be the same as or similar to one or more speakers illustrated in speaker configuration 200, one or more speakers in speaker groups 108A-108B, and/or one or more speakers referred to throughout the present disclosure. In particular, speaker 300 may include, but is not limited to, speaker electronics 304, which include a processor 308, a memory 312, a communication interface 320, an antenna 324, and an amplifier 336. The speaker 300 may also include one or more mechanical speaker drivers 340 and a power source 344. Processor 308 is provided to execute instructions contained within memory 312. Accordingly, the processor 308 may be implemented as any suitable type of microprocessor or similar type of processing chip, such as any general-purpose programmable processor, digital signal processor (DSP), or controller for executing application programming contained within memory 312. Alternatively, or in addition, the processor 308 and memory 312 may be replaced or augmented with an application specific integrated circuit (ASIC), a programmable logic device (PLD), or a field programmable gate array (FPGA).

The memory 312 generally comprises software routines facilitating, in operation, pre-determined functionality of the speaker 300. The memory 312 may be implemented using various types of electronic memory generally including at least one array of non-volatile memory cells (e.g., Erasable Programmable Read Only Memory (EPROM) cells or flash memory cells, etc.) The memory 312 may also include at least one array of Dynamic Random Access Memory (DRAM) cells. The content of the DRAM cells may be pre-programmed and write-protected thereafter, whereas other portions of the memory may be selectively modified or erased. The memory 312 may be used for either permanent data storage or temporary data storage.

The communication interface(s) 320 may be capable of supporting multichannel audio, multimedia, and/or data transfers over a wireless network. Alternatively, or in addition, the communications interface 320 may comprise a Wi-Fi, BLUETOOTH™, WiMAX, infrared, NFC, and/or other wireless communications links. The communication interface 320 may be associated with one or more shared or a dedicated antenna 324. The type of medium used by the speaker 300 to communicate with other speakers 300, mobile communication devices 120, and/or the audio/video processing unit 112, may depend upon the communication application's availability on the speaker 300 and/or the availability of the communication medium.

The communication interface 320 may also include one or more memories 328 and one or more processors 332. The processor 332 may be the same as or similar to that of the processor 308 while memory 328 may be the same as or similar to that of the memory 312. That is, the processor 332 is provided to execute instructions contained within the memory 328. Accordingly, the processor 332 may be implemented as any suitable type of microprocessor or similar type of processing chip, such as any general-purpose programmable processor, digital signal processor (DSP) or controller for executing application programming contained within memory 328. Alternatively, or in addition, the processor 332 and memory 328 may be replaced or augmented with an application specific integrated circuit (ASIC), a programmable logic device (PLD), or a field programmable gate array (FPGA).

The memory 328 generally comprises software routines facilitating, in operation, pre-determined functionality of the communication interface 320. The memory 328 may be implemented using various types of electronic memory generally including at least one array of non-volatile memory cells (e.g., Erasable Programmable Read Only Memory (EPROM) cells or flash memory cells, etc.). The memory 328 may also include at least one array of Dynamic Random Access Memory (DRAM) cells. The content of the DRAM cells may be pre-programmed and write-protected thereafter, whereas other portions of the memory may be selectively modified or erased. The memory 328 may be used for either permanent data storage or temporary data storage. The processor 308, memory 312, communication interface 320, and amplifier 336 may communicate with one another over one or more communication buses or connection 316.

Referring again to FIG. 3, the speaker 300 may include one or more amplifiers 336 that may amplify a signal associated with audio data to be output via one or more speaker coils 340. In some embodiments and consistent with the present disclosure, the speaker 300 may include one or more amplifiers 336, speaker coils 340, and/or speaker assemblies directed to one or more specific frequency ranges. For example, the speaker 300 may include an amplifier and/or speaker coil to output sounds of a low frequency range, an amplifier and/or speaker coil to output sounds of a medium frequency range, and/or an amplifier and/or speaker coil to output sounds of a high frequency range.

Speaker 300 may also include one or more power sources 344 for providing power to the speaker 300 and the components included in speaker 300. The power source 344 may be one of many power sources. Though not illustrated, the speaker 300 may also include one or more locating or location systems. In accordance with embodiments of the present disclosure, the one or more locating systems may provide absolute location information to other components of the wireless audio/video distribution system 100. In some embodiments, a location of the speaker 300 may be determined by the device's location-based features, a location signal, and/or combinations thereof. The location-based features may utilize data from one or more systems to provide speaker location information. For example, a speaker's location may be determined by an acoustical analysis of sound emanating from the speaker in reference to a known location. In some embodiments, sound emanating from the speaker may be received by a microphone associated with the mobile device 120. Accordingly, the acoustical analysis of the received sound, with reference to a known location, may allow one or more systems to determine a location of the speaker. The speaker 300 may additionally include an indicator which may be utilized to visually identify the speaker 300 during a speaker assignment process.

In some embodiments, the speaker 300 may not implement its own management. Rather, the association of speakers to groups and their locations may be kept track of by a host device, such as speaker 300, an audio/video processing unit 112, a mobile device 120, and/or combinations thereof. That is, the speaker 300 plays whatever is sent to it and it is up to the host to decide which channel to send to a specific speaker and when the speaker plays back the specific audio channel.

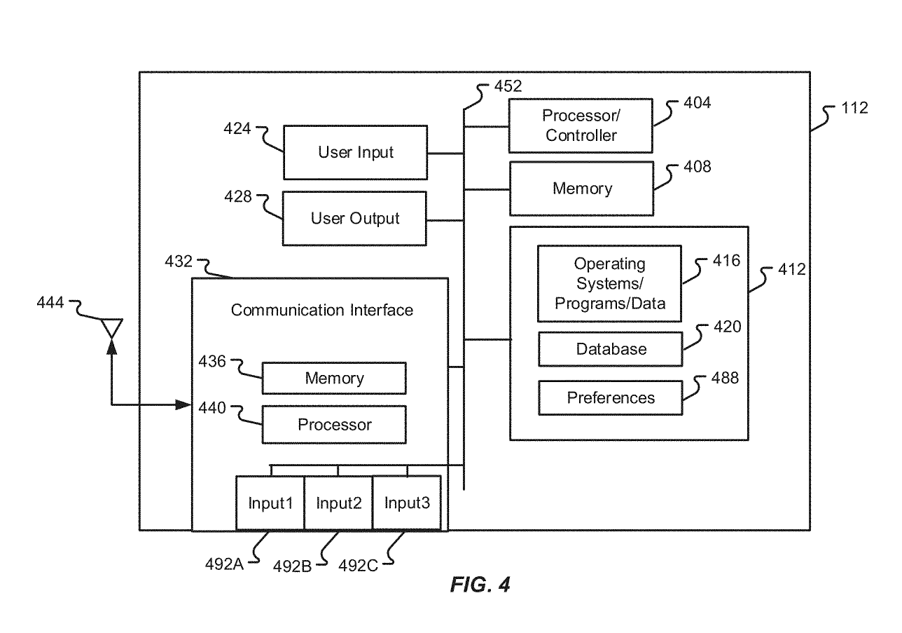

FIG. 4 illustrates a block diagram of one or more audio/video processing unit(s) 112 in accordance with embodiments of the present disclosure. The audio/video processing unit 112 may include a processor/controller 404, memory 408, storage 412, user input 424, user output 428, a communication interface 432, antenna 444, a speaker discovery and assignment module, and a system bus 452. The processor 404 may be implemented as any suitable type of microprocessor or similar type of processing chip, such as any general-purpose programmable processor, digital signal processor (DSP) or controller for executing application programming contained within memory 408. Alternatively, or in addition, the processor/controller 404 and memory 408 may be replaced or augmented with an application specific integrated circuit (ASIC), a programmable logic device (PLD), or a field programmable gate array (FPGA).

The memory 408 generally comprises software routines facilitating, in operation, pre-determined functionality of the audio/video processing unit 112. The memory 408 may be implemented using various types of electronic memory generally including at least one array of non-volatile memory cells (e.g., Erasable Programmable Read Only Memory (EPROM) cells or flash memory cells, etc.). The memory 408 may also include at least one array of Dynamic Random Access Memory (DRAM) cells. The content of the DRAM cells may be pre-programmed and write-protected thereafter, whereas other portions of the memory may be selectively modified or erased. The memory 408 may be used for either permanent data storage or temporary data storage.

Alternatively, or in addition, data storage 412 may be provided. The data storage 412 may generally include storage for programs and data. For instance, with respect to the audio/video processing unit 112, data storage 412 may provide storage for a database 420. Data storage 412 associated with an audio/video processing unit 112 may also provide storage for operating system software, programs, and program data 416. Preferences 488 may provide storage for one or more user preferences, such as accent, and/or screen overlay color, as will be described.

Similar to the communication interface 320, the communication interface(s) 432 may be capable of supporting multichannel audio, multimedia, and/or data transfers over a wireless network. The communication interface 432 may comprise a Wi-Fi, BLUETOOTH™, WiMAX, infrared, NFC, and/or other wireless communications links. The communication interface 432 may include a processor 440 and memory 436; alternatively, or in addition, the communication interface 432 may share the processor/controller 404 and memory 408 of the audio/video processing unit 112. The communication interface 432 may be associated with one or more shared or dedicated antennas 444. The communication interface 432 may additionally include one or more multimedia interfaces for receiving multimedia content. As one example, the communication interface 432 may receive multimedia content utilizing one or more multimedia interfaces, such as a high-definition multimedia interface (HDMI), coaxial interface, and/or similar media interfaces. Alternatively, or in addition, the audio/video processing unit 112 may receive multimedia content from one or more devices utilizing the communication network 104, such as, but not limited to, mobile device 120 and/or a multimedia content provider. Alternatively, or in addition, one or more dedicated input ports 492A-492C may be present. Such dedicated input ports may correspond to one of a plurality of audio/video input ports, for example HDMI.

In addition, the audio/video processing unit 112 may include one or more user input devices 424, such as a keyboard, a pointing device, and/or a remote control 124. Alternatively, or in addition, the audio/video processing unit 112 may include one or more output devices 428, such as a television 116 and/or a speaker 300. A user input 424 and user output 428 device can comprise a combined device, such as a touch screen display. Moreover, the user input device 424 may generate one or more graphical user interfaces for display on the television 116 or other device while the user output device 428 may receive input from the graphical user interface and/or a combination of the graphical user interface and another input device, such as the remote control 124.

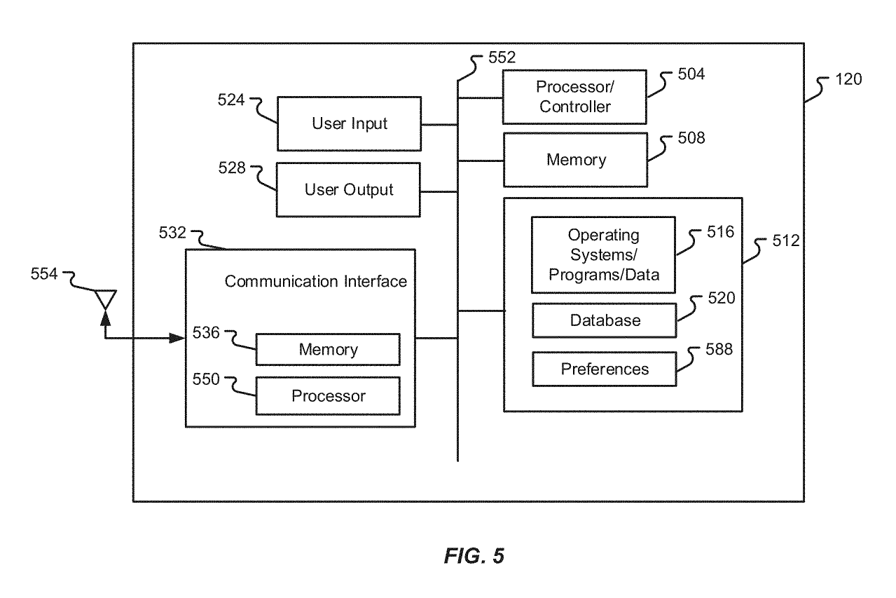

FIG. 5 illustrates a block diagram of one or more mobile devices 120 in accordance with embodiments of the present disclosure. The mobile device 120 may include a processor/controller, memory, operating systems/programs data, one or more databases, preferences for running one or more apps that may be in communication with or otherwise interface with an audio/video processing unit 112, a communication interface that includes memory and a processor, and user input and output. For example, mobile device 120 may include a processor/controller 504, memory 508, storage 512, user input 524, user output 528, a communication interface 532, antenna 544, and a system bus 552. The processor 504 may be implemented as any suitable type of microprocessor or similar type of processing chip, such as any general-purpose programmable processor, digital signal processor (DSP) or controller for executing application programming contained within memory 508. Alternatively, or in addition, the processor/controller 504 and memory 508 may be replaced or augmented with an application specific integrated circuit (ASIC), a programmable logic device (PLD), or a field programmable gate array (FPGA).

The memory 508 generally comprises software routines facilitating, in operation, pre-determined functionality of the mobile device 120. The memory 508 may be implemented using various types of electronic memory generally including at least one array of non-volatile memory cells (e.g., Erasable Programmable Read Only Memory (EPROM) cells or flash memory cells, etc.). The memory 508 may also include at least one array of Dynamic Random Access Memory (DRAM) cells. The content of the DRAM cells may be pre-programmed and write-protected thereafter, whereas other portions of the memory may be selectively modified or erased. The memory 508 may be used for either permanent data storage or temporary data storage.

Alternatively, or in addition, data storage 512 may be provided. The data storage 512 may generally include storage for programs and data. For instance, with respect to the mobile device 120, data storage 512 may provide storage for a database 520. Data storage 512 associated with the mobile device 120 may also provide storage for operating system software, programs, and program data 516. Preferences 588 may provide storage for one or more user preferences, such as accent, and/or screen overlay color, as will be described.

Similar to the communication interface 320, the communication interface(s) 532 may be capable of supporting multichannel audio, multimedia, and/or data transfers over a wireless network. The communication interface 532 may comprise a Wi-Fi, BLUETOOTH™, WiMAX, infrared, NFC, and/or other wireless communications links. The communication interface 532 may include a processor 550 and memory 536; alternatively, or in addition, the communication interface 532 may share the processor/controller 504 and memory 508 of the mobile device 120. The communication interface 532 may be associated with one or more shared or dedicated antennas 544. The communication interface 532 may additionally include one or more multimedia interfaces for receiving multimedia content and/or providing multimedia content. As one example, the communication interface 532 may provide multimedia content utilizing one or more multimedia interfaces, such as a high-definition multimedia interface (HDMI), coaxial interface, and/or similar media interfaces.

In addition, the mobile device 120 may include one or more user input devices 524, such as a touch input. Alternatively, or in addition, the user input device 524 may generate one or more graphical user interfaces for display on the television 116 or other device while the user output device 528 may cause such graphical user interfaces to be displayed on the television 116.

In accordance with embodiments of the present disclosure, the mobile device 120 may interact with the audio/video processing unit 112 to select or otherwise modify one or more preferences. Such preferences may be stored at the mobile device 120 and/or at the audio/video processing unit 112. An example of a preference that may be modified includes, but is not limited to, a screen overlay color. In instances where one or more mobile devices 120 control, interact with, or are otherwise paired to one or more audio/video processing units 112, a color of the screen overlay displayed by the audio/processing device 112 to the television 116 may be configured. Further, when displaying interactive and/or static controls associated with the particular audio/video processing unit 112 at the mobile device 120, the color associated with the interactive and/or static controls may be the same as the screen overlay color of the display by the audio/processing device 112 to the television 116. Accordingly, a user controlling multiple audio/processing devices 112 can more easily and more quickly identify which audio/video processing unit 112 they are controlling based on the color shown at the mobile device 120.

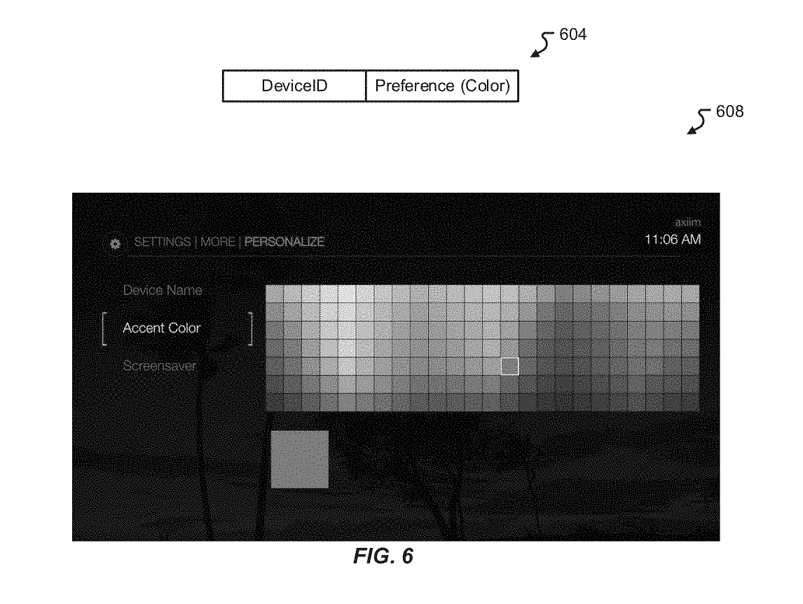

In accordance with embodiments of the present disclosure, FIG. 6 illustrates a data structure 604 and a screen accent color picker 608. The data structure 604 may be utilized to identify which audio/video processing unit 112 is associated with which color. For example, a deviceID associated with the audio/video processing unit 112 may be associated with a preference, such as an accent color. Accordingly, an app or application interfacing with the chosen or particular audio/video processing unit 112 may query the preference, such as color, associated with the deviceID and update a corresponding configuration, or preference, associated with the app running locally on the mobile device 120.

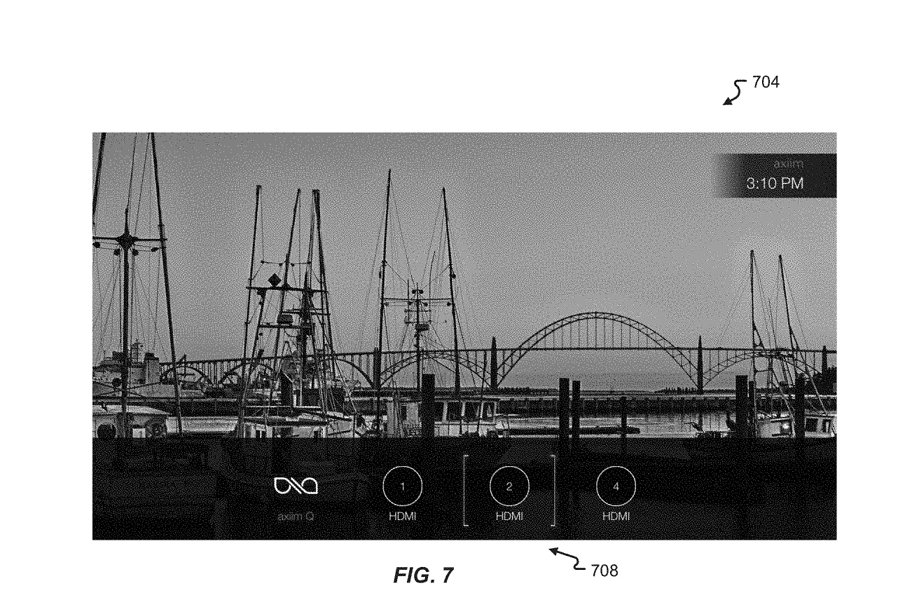

FIGS. 7-10 depict a series of screen shots provided by the audio/video processing unit 112 and displayed on the one or more televisions 116 where one or more images, graphics, and/or icons are associated with a respective input, for example input 492A. For example, FIG. 7 generally depicts a screen, or output 704, having three connected input devices. Such device may be connected to a first HDMI port, a second HDMI port, and fourth HDMI port. Examples of such ports include, but are not limited to, HDMI ports 492A-492C. Alternatively, or in addition, the input device may correspond to one or more content sources and/or content providers. For example, the input device and thus the input port may correspond to a USB device having one or more images, songs, movies, and/or galleries of multimedia content for example, a network connected content source, such as a shared or mapped network location on a local or remote intranet or accessible via the Internet, and/or other content sources generally available in the cloud.

Initially, and if such input device/content source is not already associated with an icon, a generic identifier 708, such as HDMI 2, may be initially displayed as depicted in FIG. 7. The audio/video processing unit 112 may then communicate with the connected device 180 to determine and identify what device 180 is connected. For example, the audio/video processing unit 112 may communicate with a connected device 180 using CEC over an HDMI cable to retrieve information representative of a device identifier and/or device manufacturer. Such device information may then be matched to one or more existing icons illustrative of or otherwise indicative of the content source. Such icon may reside within the database 420 for example, and/or may be provided from a server or other content provider 154.

The matching of the icon to the content source information may occur automatically or manually. For example, utilizing content/input source identification information, such as a device identifier received via CEC, a preexisting icon may be selected based on such identification information. The selected icon may automatically be displayed instead of the default icon HDMI2 for example.

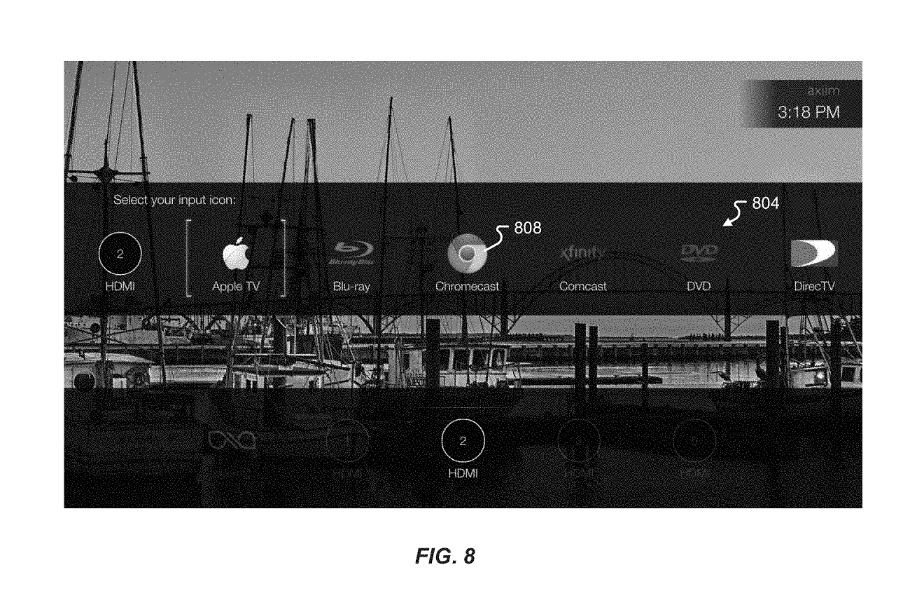

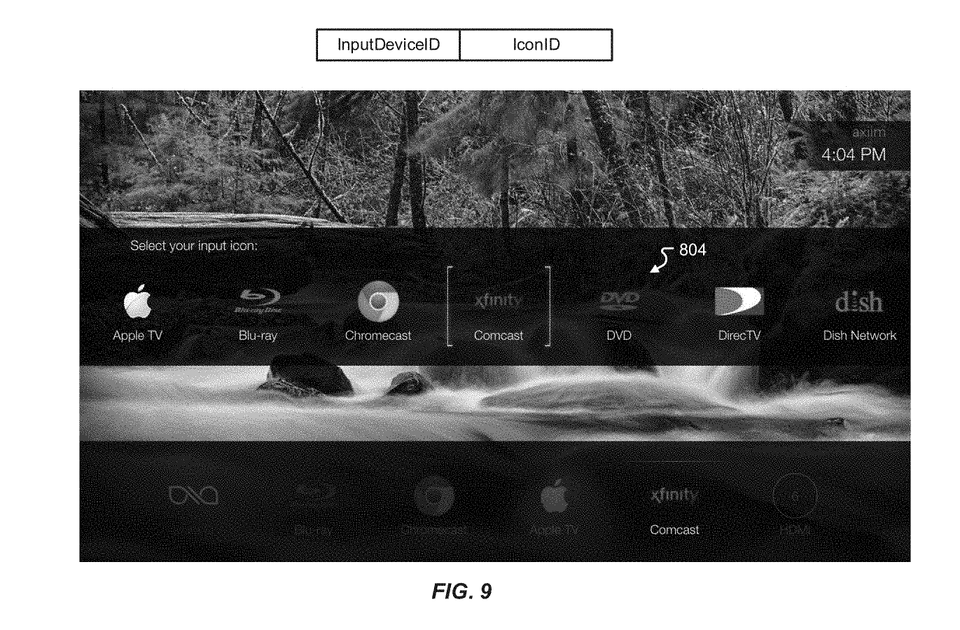

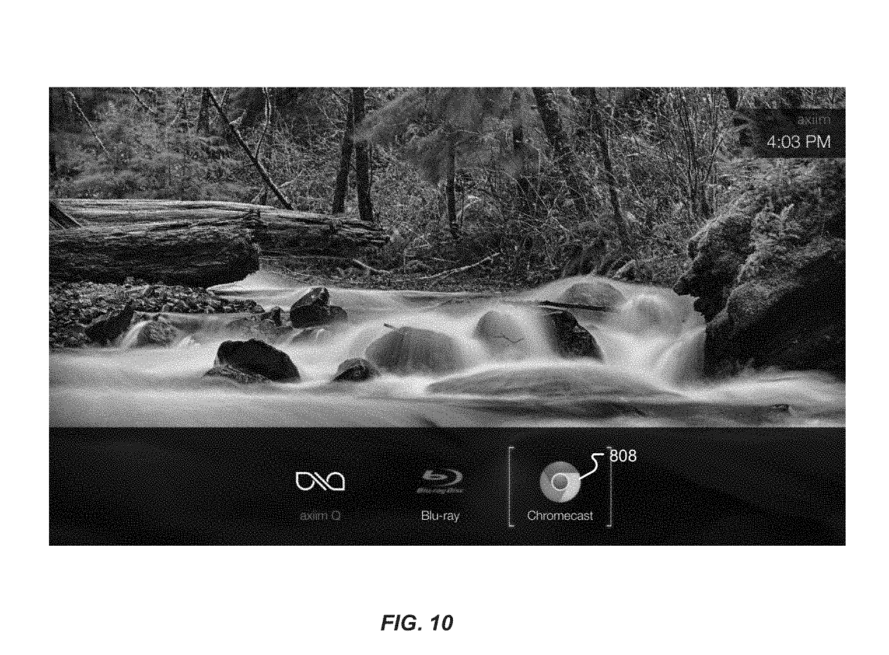

Alternatively, or in addition, a user may have the option to initially select the icon associated with an input source and/or change the icon associated with an input source at a later point in time. For example, and as depicted in FIGS. 8-9, a user may select HDMI2 and be presented with various icons 804 to select from, where each icon is representative of a different content source. For example, if a user were to select a Chromecast icon 808, for example, then the Chromcast icon may be set or otherwise associated with the connected input device—in this case a Chromecast device, as depicted in FIG. 10. Accordingly, when the Chromecast device is connected to the audio/video processing unit 112 for example, based on the device identifier communicated from the device to the audio/video processing unit 112, the previously selected icon may be retrieved from the database 420 and/or preferences 488 and displayed or otherwise rendered to a display, such as the television 116.

Alternatively, or in addition, the graphic content provider, such as server 154 may provide the icons representative of a content source as illustrated in FIGS. 8 and 9. Alternatively, or in addition, the server 154 may continually update or otherwise populate a collection of icons stored at the audio/video processing unit 112. Alternatively, or in addition, a user may upload a custom graphic or icon, indicative of a source of content, to the audio/video processing unit 112; accordingly, such icon may be available to a user such that the user can select and associate the icon with an input device and/or content source.

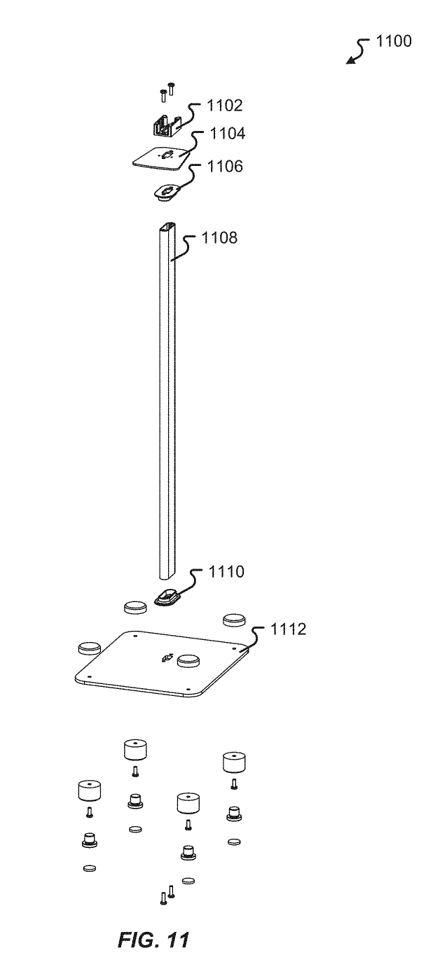

FIG. 11 generally depicts a speaker stand assembly 1100 in accordance with another embodiment of the present disclosure. The speaker stand assembly 1100 may be utilized with any of the previously mentioned speakers. For example, the speaker stand assembly may be utilized with a side speaker 208. The speaker stand assembly 1100 may include a stand platform 1104, a mount locator 1102, a top flange 1106, a stand upright 1108, a bottom flange 1110 and a stand base 1112. Of course, more or less elements may be included in the speaker stand assembly 1100. For example, fastening hardware, feet, pads, and adjusters may be included. The mount locator 1102 generally mates with or otherwise secures one of the speakers. The speaker stand assembly 1100 may generally include one or more portions that allow a power wire or cord to be threaded through the speaker stand assembly 1100. For example, each of the stand platform 1104, the mount locator 1102, the top flange 1106, the stand upright 1108, the bottom flange 1110 and the stand base 1112 may include a hollow portion or hole as depicted.

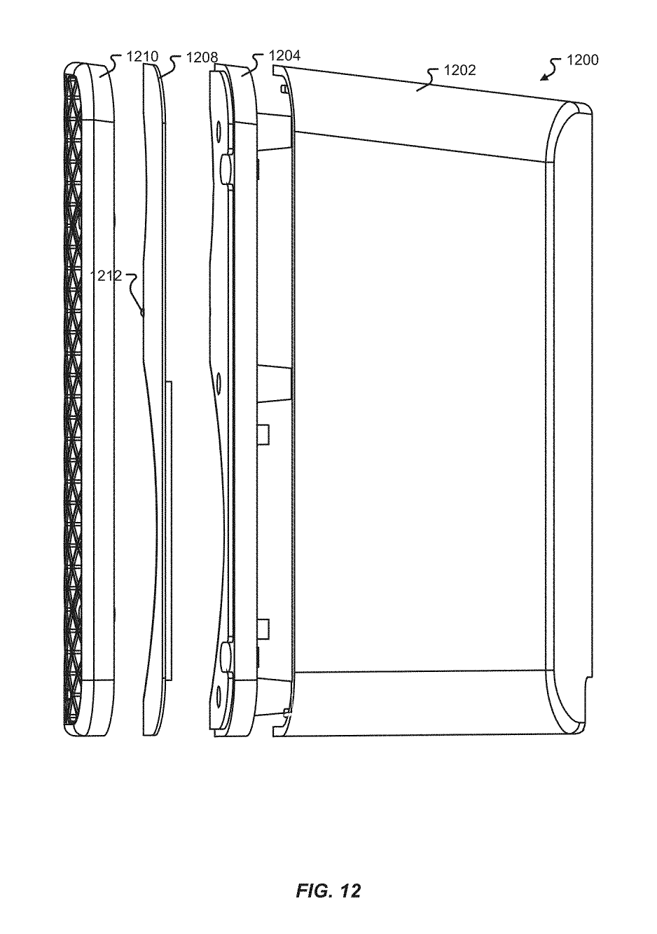

FIG. 12 generally depicts a speaker assembly 1200 in accordance with embodiments of the present disclosure. The speaker assembly 1200 may include a speaker enclosure 1202, a baffle 1204, a face pad 1208, and a grill 1210. The face pad 1208 may include a mechanic actuator or lever 1212 for example, to interact with or otherwise depress one or more buttons 1304 located on the baffle 1204. Such buttons may cause the speaker to perform one or more functions, such as reset a current configuration, initiate a pairing process, and/or perform a general reset. Of course, more or less elements may be included in the speaker assembly 1200. For example, the speaker assembly may further include a bezel, speaker drivers, and/or additional components described with respect to speaker 300.

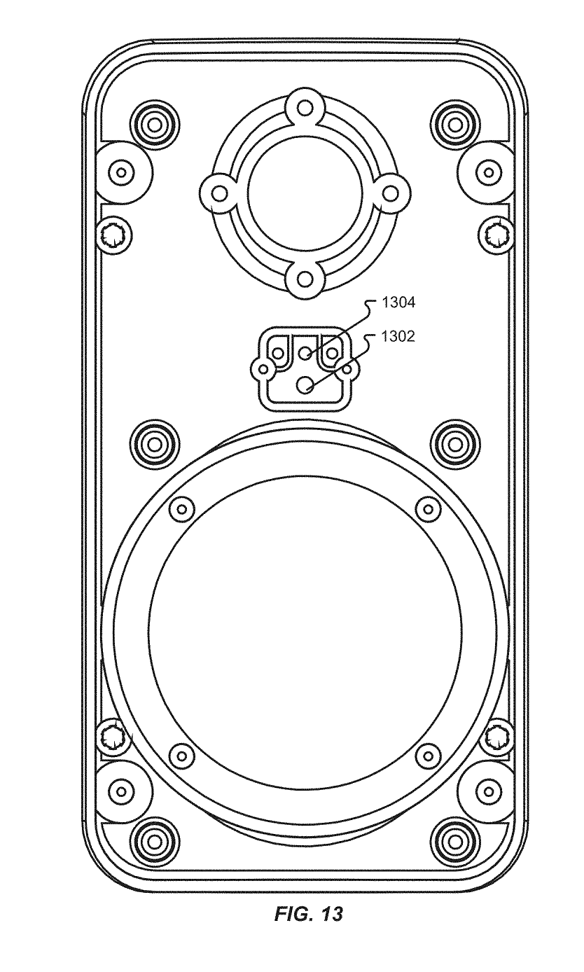

FIG. 13 generally depicts additional details of the baffle 1204. Specifically, FIG. 13 generally depicts a front view of the baffle 1204. The baffle 1204 may include an indicator 1302 and/or one or more buttons 1304. Of course, the indicator 1302 and the one or more buttons 1304 may be in various positions and need not be limited to the locations depicted.

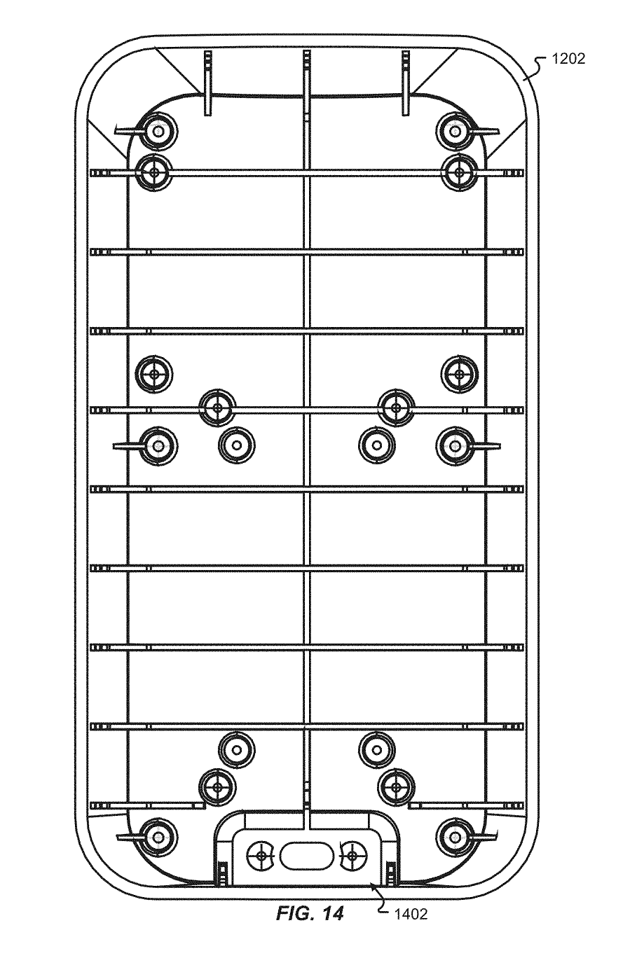

FIG. 14 generally depicts a front view of the enclosure 1202. The enclosure 1202 may include a recess portion 1402 for receiving or otherwise mounting with the mount locator 1102.

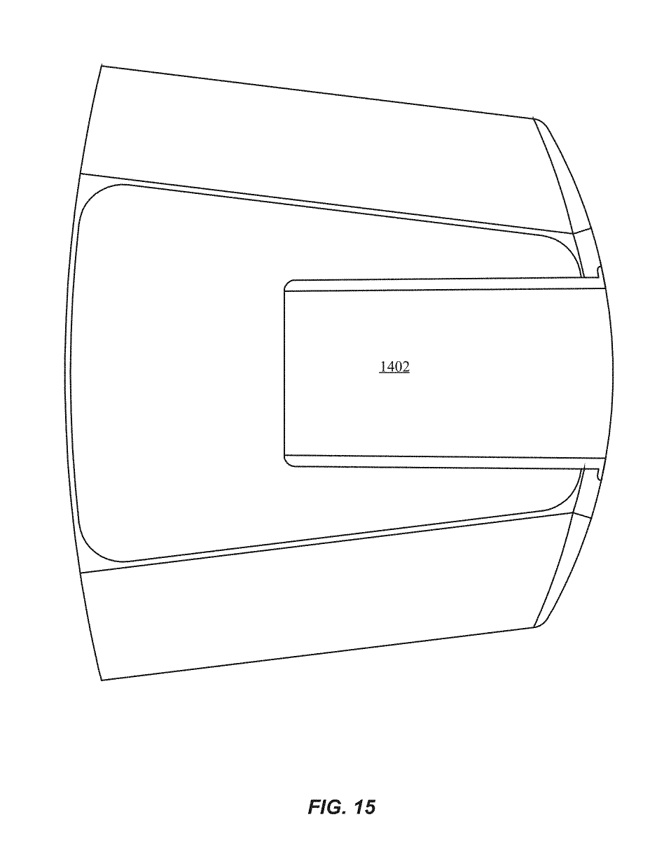

FIG. 15 generally depicts a bottom view of the enclosure 1202. In particular, FIG. 15 illustrates a recess portion 1402 that receives or otherwise mounts with the mount locator 1102.

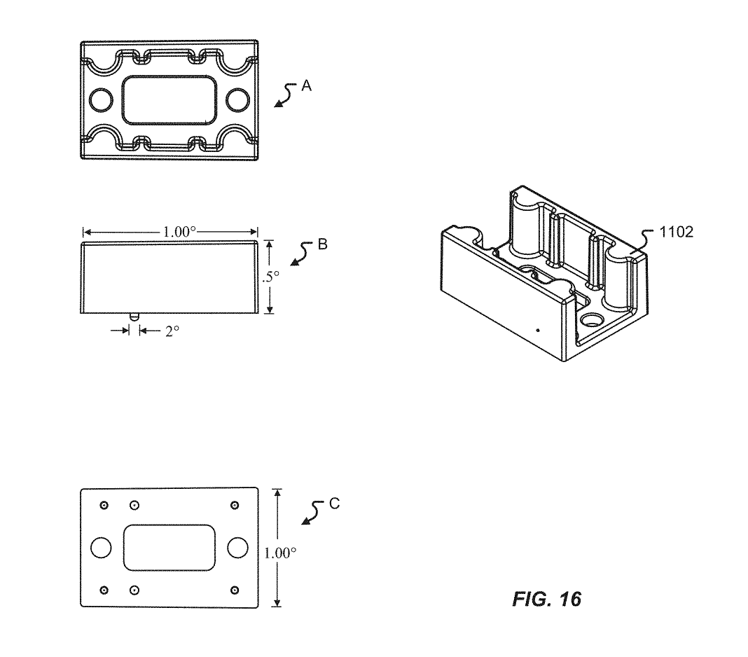

FIG. 16 generally depicts additional details of the mount locator 1102. Specifically, a top view A, side view B, and bottom view C are depicted. As depicted in at least FIG. 16, various portions of the mount locator may be tapered or otherwise angled. Accordingly, the mount locator 1102 may be inserted into the recess portion 1402 such that the mount locator 1202 is secured to the speaker enclosure 1100 and/or the speaker enclosure 1202 is secured to the mount locator 1102.

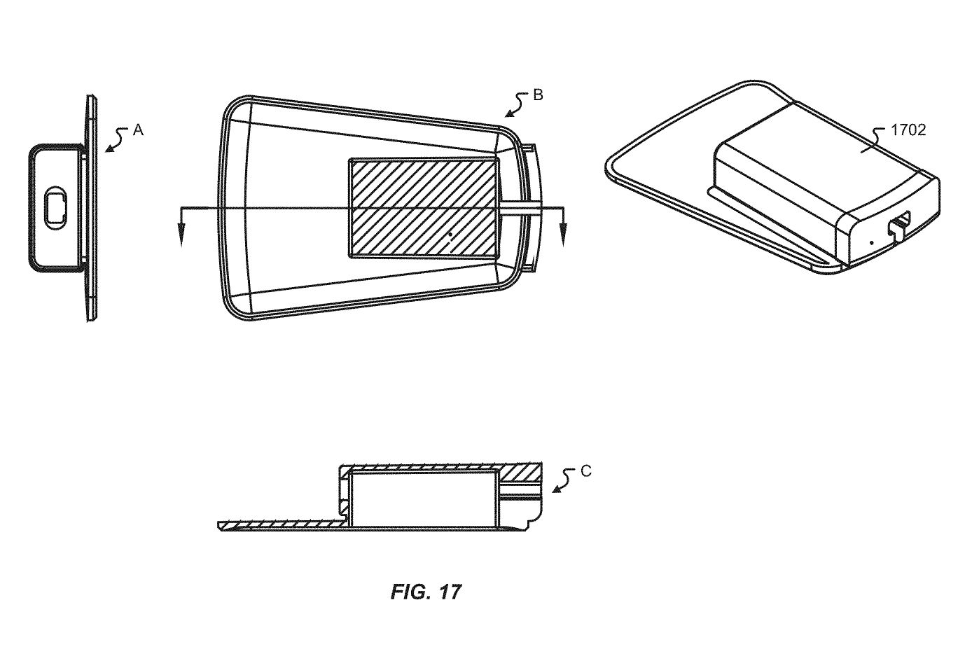

FIG. 17 generally depicts details of a foot 1702. A portion of the foot 1702 may inserted into the recess portion 1402 of the speaker enclosure 1202.

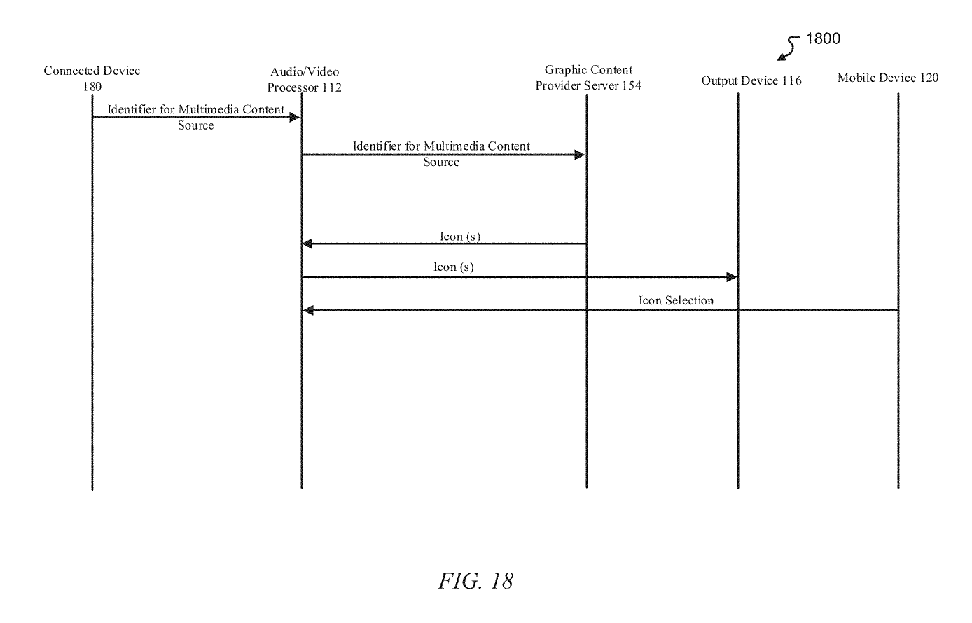

As depicted in FIG. 18, a first communication flow diagram 1800 is provided in accordance with embodiments of the present disclosure. The multimedia content source 180 may provide an identifier to the audio/video processor 112, for example by HDMI-CEC. The audio/video processor 112 may determine, from local storage, if an icon has been assigned to an identifier. If not, the audio/video processor 112 may present one or more icons to the display 116. Alternatively, or in addition, the audio/video processor 112 may send the identifier to the graphic content provider server 154 and receive form the graphic content provider server 154, one or more icons. The icons may then be displayed at the output device 116. The audio/video processor 112 may then receive, from one or more mobile devices 120, a selection of an icon; the audio/video processor 112 may then assign the icon to the identifier.

Embodiments include a method for assigning an icon to a multimedia content source, the method including: obtaining, at an audio/video processing device, an identifier for the multimedia content source, using the identifier to locate an icon, and displaying the icon at an output device. Aspects of the method may include: receiving the identifier for the multimedia content source automatically from the multimedia content source. Additional aspects may include: automatically transmitting the identifier for the multimedia content source over a communication network to a graphic content provider server, and receiving, over the communication network and from the graphic content provider server, the icon. Additional aspects may include where the identifier for the multimedia content source includes one or more of information identifying the multimedia content source and/or information representative of a multimedia content source manufacturer. Additional aspects may include where the identifier for the multimedia content source is received from the multimedia content source using High-Definition Multimedia Interface Consumer Electronic Control (HDMI-CEC). Additional aspects may include displaying a plurality of icons to the display device, receiving a selection indicating that an icon of the plurality of icons has been selected, and associating the selected icon with the multimedia content source. Additional aspects may include where the selection indicating that an icon of the plurality of icons has been selected is received over the communication network from a mobile device. Additional aspects may include assigning the icon to the multimedia content source, and storing the icon at the audio/video processing device. Additional aspects may include displaying, at the output device, a color selection display including a plurality of colors, receiving, at the audio/video processor from a mobile device and over a communication network, a selected color, updating a display preference at the audio/video processor with the selected color, and causing a display preference at the mobile device to be updated with the selected color.

Embodiments include a method comprising displaying, at an output device, a color selection display including a plurality of colors, receiving, at an audio/video processor from a mobile device and over a communication network, a selected color, updating a display preference at the audio/video processor with the selected color, and causing a display preference at the mobile device to be updated with the selected color. Additional aspects may include obtaining, at the audio/video processing device, an identifier for a multimedia content source, using the identifier to locate an icon, assigning the icon to the multimedia content source, storing the icon at the audio/video processing device, and displaying the icon at the output device.

Embodiments include a system including: an audio/video processing device, a mobile device, an output device, a multimedia content source, and a graphic content provider server, wherein, the audio/video processing device includes computer executable instructions, that when executed by a processor of the audio/video processing device, causes the audio/video processing device to: receive an identifier for the multimedia content source automatically from the multimedia content source using High-Definition Multimedia Interface Consumer Electronic Control (HDMI-CEC), automatically transmit the identifier for the multimedia content source over a communication network to a graphic content provider server, receive, over the communication network and from the graphic content provider server, the icon, display the icon at the output device, and receive the identifier for the multimedia content source automatically from the multimedia content source. Additional aspects include where the computer executable instructions, when executed by the processor of the audio/video processing device, cause the audio/video processing device to display a plurality of icons to the display device, receive a selection from the mobile device indicating that an icon of the plurality of icons has been selected, and associate the selected icon with the multimedia content source. Additional aspects include where the computer executable instructions, when executed by the processor of the audio/video processing device, cause the audio/video processing device to assign the icon to the multimedia content source, and store the icon at the audio/video processing device. Additional aspects include where the computer executable instructions, when executed by the processor of the audio/video processing device, cause the audio/video processing device to display, at the output device, a color selection display including a plurality of colors, receive, at the audio/video processor from the mobile device and over a communication network, a selected color, update a display preference at the audio/video processor with the selected color, and cause a display preference at the mobile device to be updated with the selected color.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

In the foregoing description, for the purposes of illustration, methods were described in a particular order. It should be appreciated that in alternate embodiments, the methods may be performed in a different order than that described. Further, it will be understood by one of ordinary skill in the art that the embodiments may be practiced without specific details as described herein. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for assigning an icon to a multimedia content source comprising:
obtaining, at an audio/video processing device, an identifier for the multimedia content source;
using the identifier to locate an icon; and
displaying the icon at an output device.

2. The method of claim 1, further comprising:
receiving the identifier for the multimedia content source automatically from the multimedia content source.

3. The method of claim 2, further comprising:
automatically transmitting the identifier for the multimedia content source over a communication network to a graphic content provider server; and
receiving, over the communication network and from the graphic content provider server, the icon.

4. The method of claim 3, wherein the identifier for the multimedia content source includes one or more of information identifying the multimedia content source and/or information representative of a multimedia content source manufacturer.

5. The method of claim 4, wherein the identifier for the multimedia content source is received from the multimedia content source using High-Definition Multimedia Interface Consumer Electronic Control (HDMI-CEC).

6. The method of claim 5, further comprising:
displaying a plurality of icons to a display device,
receiving a selection indicating that an icon of the plurality of icons has been selected; and
associating the selected icon with the multimedia content source.

7. The method of claim 6, wherein the selection indicating that an icon of the plurality of icons has been selected is received over the communication network from a mobile device.

8. The method of claim 7, further comprising:
assigning the icon to the multimedia content source; and
storing the icon at the audio/video processing device.

9. The method of claim 1, further comprising:
displaying, at the output device, a color selection display including a plurality of colors;
receiving, at the audio/video processor from a mobile device and over a communication network, a selected color;
updating a display preference at the audio/video processor with the selected color; and
causing a display preference at the mobile device to be updated with the selected color.

10. A method comprising:
displaying, at an output device, a color selection display including a plurality of colors;
receiving, at an audio/video processor from a mobile device and over a communication network, a selected color;
updating a display preference at the audio/video processor with the selected color; and
causing a display preference at the mobile device to be updated with the selected color.

11. The method of claim 10, further comprising:
obtaining, at the audio/video processing device, an identifier for a multimedia content source;
using the identifier to locate an icon;
assigning the icon to the multimedia content source;
storing the icon at the audio/video processing device; and
displaying the icon at the output device.

12. A system comprising:
an audio/video processing device;
a mobile device;
an output device;
a multimedia content source; and
a graphic content provider server,
wherein,
the audio/video processing device includes computer executable instructions, that when executed by a processor of the audio/video processing device, causes the audio/video processing device to:
receive an identifier for the multimedia content source automatically from the multimedia content source using High-Definition Multimedia Interface Consumer Electronic Control (HDMI-CEC),
automatically transmit the identifier for the multimedia content source over a communication network to a graphic content provider server,
receive, over the communication network and from the graphic content provider server, the icon,
display the icon at the output device, and
receive the identifier for the multimedia content source automatically from the multimedia content source.

13. The system of claim 12, wherein the computer executable instructions, when executed by the processor of the audio/video processing device, cause the audio/video processing device to:
display a plurality of icons to the display device,
receive a selection from the mobile device indicating that an icon of the plurality of icons has been selected; and
associate the selected icon with the multimedia content source.

14. The system of claim 13, wherein the computer executable instructions, when executed by the processor of the audio/video processing device, cause the audio/video processing device to:
assign the icon to the multimedia content source; and
store the icon at the audio/video processing device.

15. The system of claim 14, wherein the computer executable instructions, when executed by the processor of the audio/video processing device, cause the audio/video processing device to:
display, at the output device, a color selection display including a plurality of colors;
receive, at the audio/video processor from the mobile device and over a communication network, a selected color;
update a display preference at the audio/video processor with the selected color; and
cause a display preference at the mobile device to be updated with the selected color.
